(19) United States
(12) Patent Application Publication
(10) Pub. No.: US 2024/0367338 A1
(43) Pub. Date: Nov. 7, 2024

(54) METHOD FOR PRODUCING A RECTANGULAR WOODEN PANEL FROM INDIVIDUAL BOARDS AND WOODEN PANEL MANUFACTURING DEVICE

(71) Applicant: MINDA INDUSTRIEANLAGEN GMBH, Minden (DE)

(72) Inventor: Hubertus ZEDDIES, Hannover (DE)

(21) Appl. No.: 18/644,881

(22) Filed: Apr. 24, 2024

(30) Foreign Application Priority Data
May 3, 2023 (DE) 10 2023 111 446.8

(51) Int. Cl. B27D 1/04; B27M 3/00; B32B 7/12; B32B 21/13; B32B 37/10; B32B 37/12; B32B 38/00

(52) U.S. Cl. CPC B27D 1/04; B27M 3/0086; B32B 7/12; B32B 21/13; B32B 37/10; B32B 37/1207; B32B 38/0004; B32B 2037/1215; B32B 2317/16; B32B 2607/00

(57) ABSTRACT

A system and method for producing a rectangular wooden panel with boards extending diagonally at an angle (α), where each of the boards has opposite longitudinal sides and transverse sides includes a trimming device for trimming the transverse sides of the boards at an angle (90°−α). The trimmed boards are transported to a position in front a joining station, and the boards are arranged at angle (α) in relation to a direction of displacement. The boards are then glued on at least the longitudinal side facing a board already located in the joining station, and then inserted into the joining station with a displacement device that includes a plurality of towing trolleys arranged on a coupling bar. The displacement device travels a displacement path in the displacement direction that runs parallel to the orientation of the transverse sides of the boards. The inserted board is pressed and glued to the board already in the joining station. These steps are repeated until a wooden panel of the desired size is achieved. Then, a triangular gusset is made with a cut running perpendicular to the transverse sides at one end of the wooden panel to produce a first right-angled side edge, and this cut-off gusset is then glued at the opposite end of the wooden panel such that a second right-angled side edge is produced. The system includes a controller which controls the cutting, gluing, pressing, joining, and displacement operations.

### FIELD OF THE INVENTION

The invention relates to a method for producing a rectangular wooden panel with boards extending diagonally at an angle, each of which has opposite longitudinal sides and transverse sides. According to a second aspect, the invention also relates to a wooden panel manufacturing device.

### BACKGROUND

EP 3 797 984 A1 discloses a rectangular wooden panel composed of a plurality of boards that extend in the longitudinal direction. Such wooden panels can be joined together to create a multi-layered composite element by joining several wooden panels at 90° to each other. This produces a cross-laminated timber panel. In a triple-layered cross-laminated timber panel, for example, the boards of the two outer panels extend in the transverse direction and the boards of the middle panel in the longitudinal direction of the cross-laminated timber panel. This makes it possible to produce a stable component that can be utilized, for example, as a wall element for a building.

A three-layer cross laminated timber panel is known, for example, from EP 3 797 984 A1.

A diagonally glued solid wood panel is known from DE 92 01 177 U1.

If the boards of the wooden panel are arranged diagonally in a joining station, glued together and used to produce a cross-laminated timber panel, the intersecting longitudinal directions of the boards increase the stability of the cross-laminated timber panel. The disadvantage of this is that the wooden panel is not rectangular upon production, but in the shape of a parallelogram. To obtain a rectangular wooden panel, the two ends have to be trimmed. This results in waste, which increases the smaller the diagonal angle α to the longitudinal edge.

DE 697 01 362 T2 describes a method for producing a glued block from elongated strips of wood with a triangular cross-section, which are laid and glued side by side alternately with strips with their base sides facing downwards and with strips with their base sides facing upwards to form the block.

### SUMMARY

On this basis, the invention aims to produce a wooden panel with boards extending diagonally at an angle α in which waste is avoided as far as possible and which is suitable for use in the production of cross-laminated timber panels.

According to a first aspect of the invention, the problem is solved by a method comprising the following steps:
a) trimming the transverse sides of the boards at an angle 90°−α,
b) transporting a trimmed board to in front of a joining station and arranging the trimmed board at angle α in relation to a direction of displacement,
c) glueing the trimmed board on at least the longitudinal side facing a board already located in the joining station,
d) inserting the trimmed board into the joining station with a displacement device, wherein
e) the displacement device comprises a plurality of towing trolleys that are arranged at the angle α in relation to the direction of displacement and that are each attached to coupling rods of different lengths which travel a displacement path in the displacement direction, said path running parallel to the orientation of the transverse sides,
f) pressing and glueing the inserted board to the board already in the joining station,
g) repeating steps b) to f) until a wooden panel of the desired size is achieved, h) cutting off a triangular gusset with a cut S running perpendicular to the transverse sides at one end of the wooden panel to produce a first right-angled side edge,
i) glueing on the cut-off gusset at the opposite end of the wooden panel such that a second right-angled side edge is produced.

This method presents a simple and cost-effective way to obtain a rectangular wooden panel. Waste is reduced to a minimum and is only determined by the saw cut. The gusset cut off at one end is displaced along the transverse sides of the boards that form the longitudinal edge of the wooden panel and glued to the opposite end of the wooden panel to match.

Viewed in the direction of displacement, the gusset is preferably cut off at the front end of the wooden panel. This simplifies the arrangement of the saw, which can be provided immediately behind the joining station. Of course, the gusset can also be cut off at the rear end.

The following further steps are preferably carried out to produce a cross-laminated timber panel:
j) producing a second wooden panel according to steps a) to i),
k) glueing an upper side of at least one of the wooden panels,
l) turning the second wooden panel about its longitudinal axis,
m) laying the second wooden panel on the upper side of the first wooden panel so that the boards of the wooden panels cross,
n) pressing the two wooden panels to produce a cross-laminated timber panel.

If the joining station is large enough, a cross-laminated timber panel can also be produced by way of the following further steps:
j) dividing the wooden panel along its vertical axis into a first partial panel and a second partial panel,
k) glueing an upper side of at least one of the partial panels,
l) turning the second partial panel about the vertical axis,
m) laying the second partial panel on the upper side of the first partial panel so that the boards of the partial panels cross,
n) pressing the two partial panels to produce a cross-laminated timber panel.

Dividing the wooden panel into two equally-sized first and second wooden panels simplifies production. The two wooden panels resulting from the bisection need only be folded about the cutting line (vertical axis of the non-divided panel) and placed with the two upper sides on top of each other.

Depending on the length of the wooden panel, it can also be divided into more than two partial panels, which can then be glued together in such a way that the boards of overlapping partial panels cross. Ultimately, the decisive factor for the number of partial panels is the desired number of diagonal layers of the cross-laminated timber panel.

During production of the wooden panel, the boards are preferably glued on at least one longitudinal side with a hot-melt adhesive. This makes joining easier, as the melted hot adhesive cools rapidly during placement and pressing due to the significantly colder boards and an adhesion between two boards is created.

To ensure that the cross-laminated timber panel has sufficient load-bearing strength, the two wooden panels or the two partial panels are preferably glued with a hot-melt adhesive. The hot-melt adhesive between the boards should not be taken into account when calculating the load-bearing strength.

During production of the wooden panel, if a fiberboard, which is preferably wider than the boards, is inserted between two adjacent boards and glued to the board already in the joining station and the subsequently inserted board, a composite panel is created that exhibits excellent insulating properties. Such a composite panel can be inserted as a middle layer between two purely wooden panels without a fiberboard and then glued and pressed together with them. The wooden panel equipped with the fiberboards forms an inner insulating layer, while the outer sides of the composite panel are made of solid wood. The number of intermediate panels between two outer panels is arbitrary.

Due to the fact that the boards are trimmed at an angle of 90°−α and arranged in front of the joining station at the angle α in relation to the direction of displacement, the joining station can be a conventional joining station in which wooden panels with boards arranged perpendicular to the direction of displacement are inserted.

According to a second aspect, the invention solves the problem by a wooden panel manufacturing device for manufacturing a rectangular wooden panel with
(a) a trim device configured to trim the transverse sides of the boards at an angle 90°−α,
(b) a feed device configured to transport a trimmed board to in front of a joining station and arranging the trimmed board at angle α in relation to a direction of displacement,
(c) a glueing station configured to glue the trimmed board on at least the longitudinal side facing a board already located in the joining station, (d) a displacement device configured to insert the trimmed board into the joining station,
(e) wherein the displacement device comprises a plurality of towing trolleys that are arranged on a coupling bar which travels a displacement path in the displacement direction, said path running parallel to the orientation of the transverse sides,
(f) the joining station configured to press and glue the inserted board to the board already in the joining station,
(g) a cut-off device configured to cut off a triangular gusset with a cut S running perpendicular to the transverse sides at one end of the wooden panel to produce a first right-angled side edge,
(h) wherein the joining station is configured to press and glue the cut-off gusset to the opposite end of the wooden panel such that a second right-angled side edge is produced.

The trim device is, for example, a milling cutter or a saw, in particular a circular saw. The feeding device is, for example, an electric pallet conveyor, a vehicle, in particular an autonomous vehicle, a lift, a shaft conveyor, an overhead conveyor, an aerial tramway, a trolley conveyor, a rail conveyor, a roller conveyor, a belt conveyor, a chain conveyor or an underfloor drag chain conveyor.

The sliding device is, for example, a slider, in particular a mechanical, pneumatic or hydraulic slider.

Preferably, the wooden panel manufacturing device has a control device configured to control the trim device, the feed device, the displacement device, the glueing station, the joining station and the cut-off device, so that the wooden panel manufacturing device automatically performs the method according to the invention.

The cut-off device is, for example, a milling cutter or a saw, in particular a circular saw.

The feed device is preferably configured to transport the cut-off gusset in the feed direction to in front of the last board already located in the joining station.

Preferably, the wooden panel manufacturing device has a handling device configured to move the cut-off gusset into the glueing station. The handling device is, for example, a gripper, a lifter, in particular a vacuum suction cup or vacuum lifter, or a handling robot.

Preferably, the glueing station is configured to glue the cut-off gusset on at least the longitudinal side facing the board already located in the joining station.

Advantageously, the towing trolleys each have a rear towing arm in the direction of displacement and a front towing arm in the direction of displacement, wherein the rear towing arms and the front towing arms can be brought into an engaged position and into a disengaged position, for example by raising or lowering the front and/or rear towing arms. Preferably, the rear towing arms are arranged, when view from above, parallel to each other at right angles to the direction of displacement and the front towing arms are arranged, when view from above, diagonally at an angle α.

### DESCRIPTION OF THE DRAWINGS

In the following, the invention will be explained in more detail with the aid of accompanying figures. They show:

FIG. 1a—the schematic representation of laying individual boards in a joining station;

FIG. 1b—the schematic representation of laying individual boards with a schematically illustrated operating station;

FIG. 1c—the cut along the line Ic-Ic according to FIG. 1b;

FIG. 2a—a laid wooden panel with a parallelogram surface;

FIG. 2b—a laid wooden panel with fiberboards in between and a parallelogram surface;

FIGS. 3a-3b—the wooden panel according to FIG. 2a after having obtained a rectangular surface; and

FIGS. 4a-4c—a further wooden board.

### DESCRIPTION

To ensure that the wooden panels 10, 20 with boards extending diagonally at an angle α can be produced in a conventional joining station F, the boards 1, 2, 3, . . . x must first be trimmed on their opposite longitudinal sides 1.1, 1.2, 2.1, 2.2, 3.1, 3.2, . . . x.1, x.2 at an angle 90°−α.

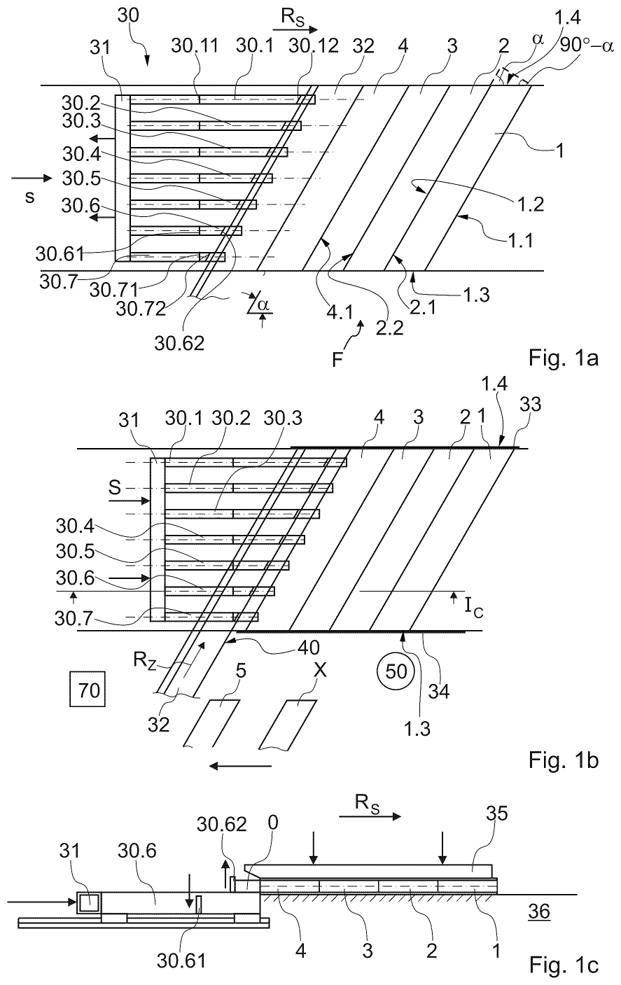

The boards 1, 2, 3, . . . , x−1, x are then transported into the joining station F, where they are positioned at an angle α in relation to the direction of displacement R_{S}. They are transported via a feed device 32, which can be designed, for example, as a conveyor belt or roller conveyor. A plurality of towing trolleys 30.1, 30.2, 30.3, 30.4, 30.5, 30.6, 30.7 are arranged in front of the joining station F, said towing trolleys also being at an angle α in relation to the direction of displacement R_{S}. Each towing trolley 30.1, 30.2, 30.3, 30.4, 30.5, 30.6, 30.7 is fixed to the coupling bar 3.1 and can be displaced parallel to the direction of displacement R_{S} via said bar in order to travel a path of displacement s. The path of displacement s also extends parallel to the orientation of the transverse sides 1.3, 1.4, 2.3, 2.4, 3.3, 3.4, . . . x.3, x.4, as shown in FIGS. 1a and 1b. Perpendicular to the direction of displacement s, the joining station F is limited by an adjustable ruler 33 and a fixed ruler 34 to allow for different lengths of the boards. The boards 1, 2, 3, . . . x rest on the sliding table 36 and are fixed to it via a pressure bar 35 (cf. FIG. 1c). The coupling bar 31 can be driven, for example, via a motor, hydraulically or pneumatically. As shown in FIGS. 1a and 1b, the towing trolleys 30.1, 30.2, . . . , 30.7 can be of different lengths to take the boards 1, 2, 3, . . . x extending diagonally at angle α into account.

A first board 1 is initially arranged in front of the joining station F and then guided via the feed device 32 to the towing trolleys 30.1, 30.2, 30.3, 30.4, 30.5, 30.6, 30.7, which simultaneously insert it into the joining station F in the direction of displacement R_{S}. In the process, the towing trolleys 30.1, 30.2, 30.3, 30.4, 30.5, 30.6, 30.7 all travel the same displacement path s until the first board 1 has reached the end position, formed by an end stop A. A second board 2 is then positioned in front of the joining station F and, at the glueing station 40, coated with a molten hot-melt adhesive on its front longitudinal side 2.1 in relation to the direction of displacement R_{S}; it is then fed via the feed device 32 and inserted into the joining station F by means of the displacement device 30 until it strikes the rear longitudinal side 1.2 of the first board 1. The hot-melt adhesive cures quickly in the process, especially because the first board 1 is significantly colder than the hot-melt adhesive. These processes are repeated until the final board x has been inserted into the joining station F and a wooden panel 10 of the desired size has been produced.

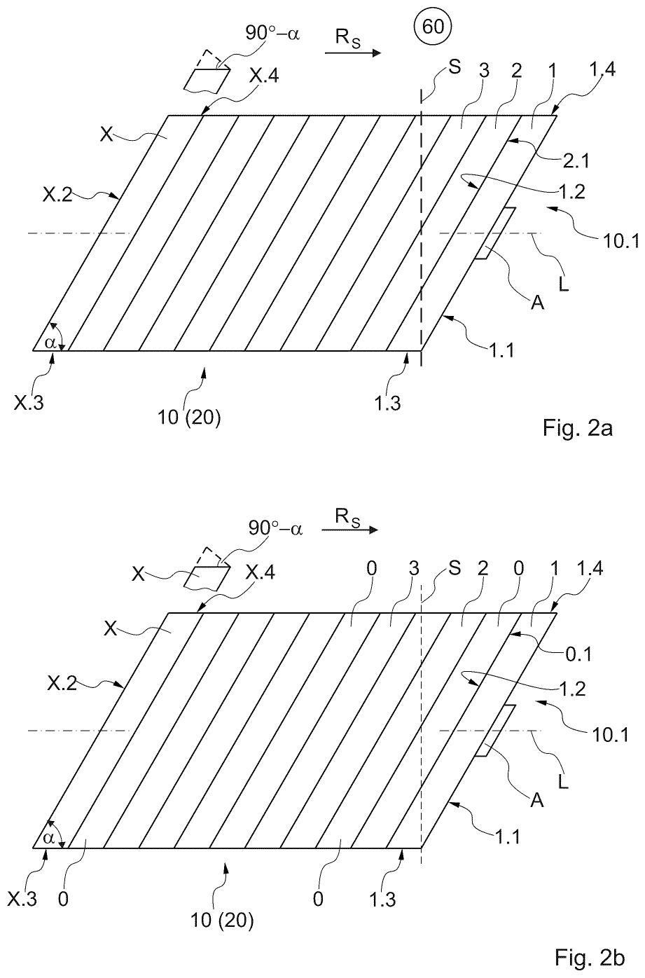

As depicted in FIG. 2A, this wooden panel 10 has a parallelogram surface. The wooden panel 10 is transported out of the joining station F and now a gusset 10.1 is cut off at the front end, viewed in the direction of displacement R_{S}, by means of a cut-off device 60, for example in the form of a saw, in particular a circular saw, by performing a vertical saw cut S in relation to the direction of displacement R_{S} or to the transverse sides 1.3, 1.4; 2.3, 2.4; 3.3, 3.; . . . x.3, x.4. Said triangular gusset 10.1 is glued to the rear end of the wooden panel 10 by coating the front longitudinal side 1.1 in relation to the direction of displacement R_{S} with a molten hot-melt adhesive, but preferably with a wood glue so as to improve its static properties, and glueing it to the longitudinal side x.2 of the last board x.

In order to produce a cross-laminated timber panel, a second wooden panel 20 is produced in the previously described manner. At least one upper side of the wooden panels 10, 20 is then glued with a wood glue. The second wooden panel 20 is turned 180° about its longitudinal axis and then placed with its upper side on the upper side of the first wooden panel 10, so that the boards 1, 2, 3, . . . x of the two wooden panels 10, 20 cross; the two wooden panels 10, 20 are then pressed to form a cross-laminated timber panel.

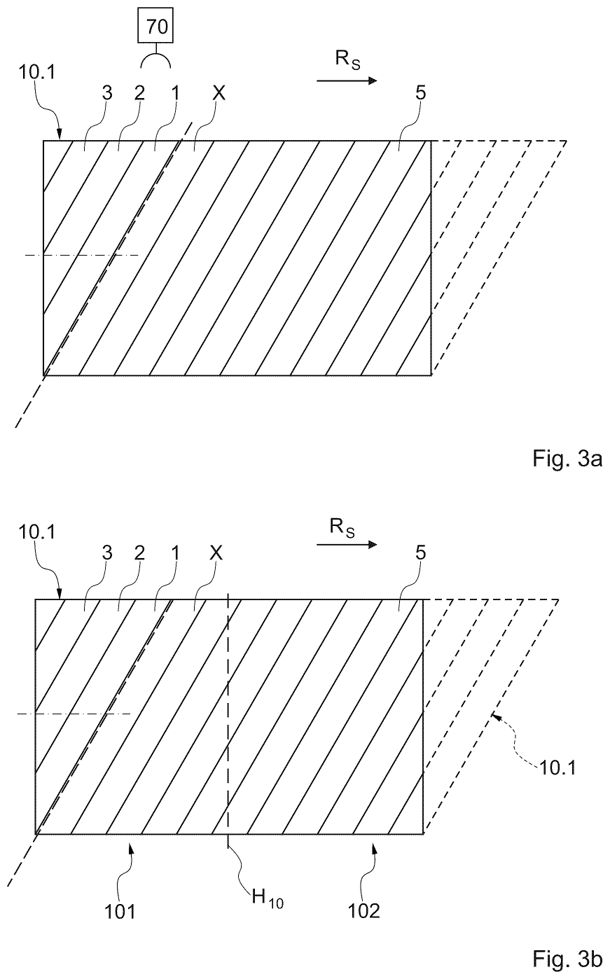

If the joining station F is long enough, a cross-laminated timber panel can also be produced from a single wooden panel 10 by dividing the rectangular wooden panel 10 along its vertical axis H₁₀ into two partial panels 101, 102 (See FIGS. 3a-3b). The upper side of at least one partial panel 101, 102 is coated with wood glue; the second partial panel 102 is then folded 180° about the vertical axis H₁₀ so that its upper side comes to rest on the upper side of the first partial panel 101 and the two partial panels 101, 102 are then pressed together.

The two methods described above enable the production of cross-laminated timber panels of any thickness. One just has to always ensure that the boards of adjacent wooden panels cross.

The towing trolleys 30.1, 30.2, . . . 30.7 each have a first towing arm 30.11, . . . 30.71 at the rear in the direction of displacement and a towing arm 30.12, . . . 30.72 at the front in the direction of displacement. The towing arms 30.11, . . . 30.71; 30.12, . . . 30.72 can be raised and lowered. To be able to insert the boards 1, 2, . . . x in the direction of displacement R_{S}, the front towing arms 30.12, . . . 30.62, 30.72 are raised. They then grip the rear longitudinal side 1.2, 2.2, . . . x.2 in the direction of displacement R_{S} in order to insert the boards 1, 2, 3, . . . x into the joining station F. In this case, the rear towing arms 30.11, . . . 30.61, 30.71 are lowered (cf. FIG. 1c). As shown in FIG. 1a, the front towing arms 30.12, . . . 30.72 are arranged diagonally at an angle α when viewed from above. The rear towing arms 30.11, . . . 30.71 are arranged, when viewed from above, parallel at a right angle to the direction of displacement R_{S}. They serve to attach the gusset 10.1 cut off at the front end of the wooden panel 10 to the rear end. For this purpose, the rear towing arms 30.11, . . . 30.71 are raised and the front towing arms 30.12, . . . 30.72 lowered. The cut-off gusset 10.1 can be moved via a handling device 80. For example, a vacuum cup may be provided that raises the cut-off gusset 10.1 and transfers it into the glueing station 40 where it is lowered. Here, the front side edge 1.1 of the board 1 is glued and the gusset 10.1 moved via the feed device 32 in the feed direction R_{Z} to in front of the last board x. The gusset 10.1 is then pushed against the last board x in the direction of displacement R_{S} via the towing arms 30.11, . . . 30.71 and pressed together with it.

A control device 70 (see FIG. 1b) is configured to control a trim device 50, the feed device 32, the displacement device 30, the glueing station 40, the joining station F, and the cut-off device 60, so that the wooden panel manufacturing device automatically performs the process according to the invention.

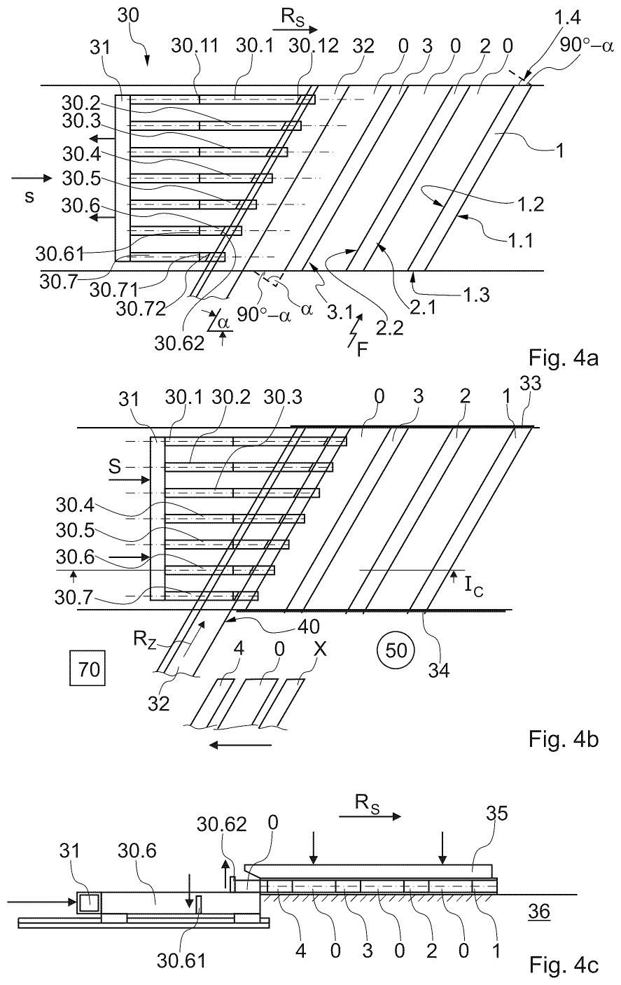

As shown in FIG. 2b, a fiberboard 0 can be inserted between each board 1, 2, 3, 4 . . . x−1, which can be designed to be wider than the boards 1, 2, 3, . . . x (see also FIGS. 4a-4c) The connection between the boards 1, 2, 3, . . . x and the fiberboard is achieved in exactly the same way as the connection between the boards 1, 2 . . . described above. The front longitudinal side 0.1 of a fiberboard 0 in the direction of displacement R_{S} is coated with a hot-melt adhesive and pushed against the rear side edge 1.2 of a board 1 already arranged in the joining station F. Boards and fiberboards are always glued together alternately. A board 1, x is provided at the beginning and end to create a solid end to the panel. One or several such panels can be used as an insulating panel in the middle layer of a cross-laminated timber panel. The two deck sides are formed from a pure wooden panel 10, 20, 101, 102 consisting only of boards 1, 2, 3, . . . x.

If the joining station F is long enough, a wooden panel 10 that has fiberboards 0 can also be divided along it vertical axis H₁₀ into two partial panels and used twice accordingly.

### REFERENCE LIST

0 fiberboard
0.1 longitudinal side
1 board
1.1 longitudinal side
1.2 longitudinal side
1.3 transverse side
1.4 transverse side
2 board
2.1 longitudinal side
2.2 longitudinal side
2.3 transverse side
2.4 transverse side
3 board
3.1 longitudinal side
3.2 longitudinal side
3.3 transverse side
3.4 transverse side
4 board
4.1 longitudinal side
4.2 longitudinal side
4.3 transverse side
4.4 transverse side
5 board . . .
x−1 board
x board
x.1 longitudinal side
x.2 longitudinal side
x.3 transverse side
x.4 transverse side
10 wooden panel
10.1 gusset
20 wooden panel
30 displacement device
30.1 towing trolley
30.2 towing trolley
30.3 towing trolley
30.4 towing trolley
30.5 towing trolley
30.6 towing trolley
30.7 towing trolley
30.11 towing arm
30.12 towing arm
30.61 towing arm
30.62 towing arm
30.71 towing arm
30.72 towing arm
31 coupling bar
32 feed device
33 adjustable ruler
34 fixed ruler
35 pressure bar
36 sliding table
40 glueing station
50 trim device
60 cut-off device
70 control device
80 handling device
101 partial panels
102 partial panels
A end stop
F joining station
H₁₀ vertical axis
L longitudinal axis
R_{S} direction of displacement
R_{Z} feed direction
S saw cut
s path of displacement
α angle

1. A method for producing a rectangular wooden panel with a plurality of boards extending diagonally at an angle (α), each board of the plurality of boards has opposite longitudinal sides and transverse sides, comprising:
a) trimming the transverse sides of each of the boards of the plurality of boards at a first trim angle (90°−α) to produced trimmed boards,
b) transporting a trimmed board to a position in front of a joining station and arranging the trimmed board at angle (α) in relation to a direction of displacement,
c) glueing the trimmed board on at least one longitudinal side facing a second board already located in the joining station,
d) inserting the trimmed board into the joining station with a displacement device, wherein
e) the displacement device comprises a plurality of towing trolleys that are arranged on a coupling bar which travels a displacement path in the displacement direction, wherein the displacement path runs parallel to an orientation of the transverse sides of the trimmed board,
f) pressing and glueing the inserted trimmed board to the second board already in the joining station,
g) repeating steps b) to f) until a wooden panel of a certain size is achieved,
h) cutting off a triangular gusset with a cut running perpendicular to the transverse sides of the plurality of boards at one end of the wooden panel to produce a first right-angled side edge, and
i) glueing on a cut-off gusset at an opposite end of the wooden panel such that a second right-angled side edge is produced.

2. The method according to claim 1, wherein the triangular gusset is cut off at a front end of the wooden panel viewed in the direction of displacement.

3. The method according to claim 1 further comprising the following steps:
j) producing a second wooden panel according to steps a) to i),
k) glueing an upper side of at least one of the wooden panel and the second wood panel,
l) turning the second wooden panel about a longitudinal axis of the second wooden panel,
m) laying the second wooden panel on an upper side of the wooden panel so that the plurality of boards of the wooden panel and the plurality of boards of the second wooden panel cross, and
n) pressing the wooden panel and the second wooden panel to produce a cross-laminated timber panel.

4. The method according to claim 1 further comprising the following:
j) dividing the wooden panel along a vertical axis of the wooden panel into a first partial panel and a second partial panel,
k) glueing an upper side of at least one of the first partial panel an the second partial panel,
l) turning the second partial panel about the vertical axis (H₁₀),
m) laying the second partial panel on an upper side of the first partial panel so that the plurality of boards of the first partial panel and the second partial panel cross, and
n) pressing the first partial panel and the second partial panel to produce a cross-laminated timber panel.

5. The method according to claim 1 wherein in step c) a hot-melt adhesive is applied to the at least one longitudinal side.

6. The method according to claim 3 wherein the wooden panel and the second wooden panel are glued with a hot-melt adhesive.

7. The method according to claim 4 wherein the first partial panel and the second partial panel are glued with a hot-melt adhesive.

8. The method according to claim 1 further comprising inserting a fiberboard between two adjacent boards of the plurality of boards and glueing the fiberboard to each of the two adjacent boards, and producing a wooden panel with fiberboards.

9. The method according to claim 8, wherein the fiberboard is wider than each of the plurality of boards.

10. The method according to claim 7 further comprising i
inserting the wooden panel with fiberboards between two wooden panels without fiberboards; and
gluing and pressing together the wooden panel with fiberboards and the two wooden panels without fiberboards.

11. A wooden panel manufacturing device for manufacturing a rectangular wooden panel, comprising:
(a) a trim device configured to trim transverse sides of each of a plurality of boards at a trim angle (90°−α),
(b) a feed device configured to transport a trimmed board to a position in front of a joining station and arranging the trimmed board at angle (α) in relation to a direction of displacement,
(c) a glueing station configured to glue the trimmed board on at least a longitudinal side facing a second board already located in the joining station,
(d) a displacement device configured to insert the trimmed board into the joining station,
(e) wherein the displacement device comprises a plurality of towing trolleys that are arranged on a coupling bar which travels a displacement path(s) in the displacement direction, wherein the displacement path runs parallel to an orientation of the transverse sides of the plurality of boards,
(f) wherein the joining station is configured to press and glue an inserted board to a second board already in the joining station,
(g) a cut-off device configured to cut off a triangular gusset with a cut running perpendicular to the transverse sides of the plurality of boards at one end of a wooden panel to produce a first right-angled side edge, and
(h) wherein the joining station is configured to press and glue the cut-off gusset to an opposite end of the wooden panel such that a second right-angled side edge is produced.

12. The wooden panel manufacturing device according to claim 11, further comprising a control device configured to control the trim device, the feed device, the displacement device, the glueing station, the joining station, and the cut-off device, so that the wooden panel manufacturing device automatically carries out a method for producing a rectangular wooden panel with a plurality of boards extending diagonally at an angle (α), each board of the plurality of boards has opposite longitudinal sides and transverse sides, comprising:
a) trimming the transverse sides of each of the boards of the plurality of boards at a first trim angle (90°−α) to produced trimmed boards,
b) transporting a trimmed board to a position in front of a joining station and arranging the trimmed board at angle (α) in relation to a direction of displacement,
c) glueing the trimmed board on at least one longitudinal side facing a second board already located in the joining station,
d) inserting the trimmed board into the joining station with a displacement device, wherein
e) the displacement device comprises a plurality of towing trolleys that are arranged on a coupling bar which travels a displacement path in the displacement direction, wherein the displacement path runs parallel to an orientation of the transverse sides of the trimmed board,
f) pressing and glueing the inserted trimmed board to the second board already in the joining station,
g) repeating steps b) to f) until a wooden panel of a certain size is achieved,
h) cutting off a triangular gusset with a cut running perpendicular to the transverse sides of the plurality of boards at one end of the wooden panel to produce a first right-angled side edge, and
i) glueing on a cut-off gusset at an opposite end of the wooden panel such that a second right-angled side edge is produced.

13. The wooden panel manufacturing device according to claim 10 wherein the feed device is configured to transport the cut-off gusset in a feed direction to a position in front of a last board already located in the joining station.

14. The wooden panel manufacturing device according to claim 10 further comprising:
(a) a handling device configured to move the cut-off gusset into the glueing station, and
(b) wherein the glueing station is configured to glue the cut-off gusset on at least a longitudinal side facing the second board already located in the joining station.

15. The wooden panel manufacturing device according to claim 10 wherein the towing trolleys each have a rear towing arm in the direction of displacement (R_{S}) and a front towing arm in the direction of displacement (R_{S}), wherein the rear towing arms and the front towing arms are configured to be brought into an engaged position and into a disengaged position, wherein the rear towing arms are arranged parallel to each other at right angles to the direction of displacement and the front towing arms are arranged diagonally at an angle (α).
